(19) United States
(12) Patent Application Publication
(10) Pub. No.: US 2013/0013611 A1
(43) Pub. Date: Jan. 10, 2013

(54) GROUPING APPARATUS, COMPUTER-READABLE RECORDING MEDIUM, AND GROUPING METHOD

(75) Inventor: Kentaro Yamasaki, Minato-ku (JP)

(73) Assignee: NEC CORPORATION, Tokyo (JP)

(21) Appl. No.: 13/636,826

(22) PCT Filed: Mar. 28, 2011
(86) PCT No.: PCT/JP2011/057671

§ 371 Date: Sep. 24, 2012

(30) Foreign Application Priority Data
Mar. 31, 2010 (JP) 2010-080662

(51) Int. Cl. G06F 17/30

(52) U.S. Cl. 707/737; 707/E17.046

(57) ABSTRACT

A grouping apparatus (1) to allow a user to join or leave one or more groups according to a state of the user, has a change storage unit (13) that associates and stores a key, which is generated based on a first attribute value to represent the state of the user at a first time point and a second attribute value to represent the state at a second time point, which is later than the first time point, and a member list difference, which shows a difference, between the first time point and the second time point, in a list of members belonging to a group which the user is allowed to join or leave, as the state of the user changes from the state at the first time point to the state at the second time point. Furthermore, the grouping apparatus (1) has a context acquisition unit (111) that acquires two-time-point context, which includes an attribute value to represent an old state of the user and an attribute value to represent a current state of the user, an information search unit (12) that searches for the member list difference corresponding to the key generated based on the attribute value to represent the old state and the attribute value to represent the current state, included in the two-time-point context acquired, from the change storage unit (13), and a transmission unit (121) that transmits the searched member list difference.

### TECHNICAL FIELD

The present invention relates to a grouping apparatus, a computer-readable recording medium and a grouping method.

### BACKGROUND ART

Heretofore, grouping methods to place users in groups (hereinafter referred to as “grouping”) have been known. A grouping method such as these includes a step of receiving as input context, which represents attribute values such as the user's age, sex, location and so on, a step of searching for grouping conditions that designate attribute values to match the attribute values represented by the input context as conditions to allow that user to belong to a given group, and a step of allowing that user to join or leave each group based on the searched grouping conditions.

Non-patent literature 1 discloses a grouping method whereby leave of a user from a group can be easily determined. This grouping method includes a step of generating a set S, which has attribute values as elements, and calculating the power set P(S), and a step of calculating the hush values of individual elements of the calculated set P(S), and, in the above matching step, searches for grouping conditions based on the hush values. Furthermore, with this grouping method, the set of elements searched out in the matching step that was previously performed with respect to the same user is P(S′), and the set of elements searched out in the matching step presently performed is P(S), and newly matching grouping conditions are specified by calculating the elements of P(S)-P(S′).

Furthermore, a grouping system to use the grouping method of non-patent literature 1 is known. This grouping system is formed with a grouping apparatus 91, a context notification apparatus 96 and a member list difference receiving apparatus 97, such as illustrated in FIG. 12.

The context notification apparatus 96 has a context transmission unit 962, and this context transmission unit 962 transmits context, which includes a user identifier to identify a user and attribute information to represent that user's attribute values, to the grouping apparatus 91.

The grouping apparatus 91 includes a key generation unit 911, an information search unit 912, a rule storage unit 913, a rule registration unit 914, a Joining/leave determining unit 915, an affiliated group updating unit 916, and an affiliated group storage unit 917.

The rule storage unit 915 associates and stores grouping rules, which define a plurality of the above grouping conditions registered with the rule registration unit 914, and group identifiers, which identify the groups for which these grouping rules define the conditions. Consequently, using the power set, the key generation unit 911 generates keys for searching for grouping rules to match the attribute values represented by the attribute information that is included in the context received from the context notification apparatus 96. Using the generated keys, the information search unit 911 searches for a grouping rule to match the received context, from the rule storage unit 913, and acquires the group identifier associated with the searched grouping rule.

The affiliated group storage unit 917 associates and stores the user identifier to identify the user and the group identifier to identify the group to which that user belongs. Consequently, from the affiliated group storage unit 916, the information search unit 912 acquires the group identifier that is associated with the user identifier included in the context (that is to say, the identifier of the group to which the user belongs). By comparing the group identifier of the matching grouping rule and the group identifier of the group to which the user belongs, the Joining/leave determining unit 915 determines as to which group the user is joining and/or which group the user is leaving. Next, according to the decision by the Joining/leave determining unit 915, that user leaves and/or joins each individual group.

After that, based on the decision result of the Joining/leave determining unit 915, the Joining/leave determining unit 915 generates information to represent member list differences, which show the differences between a list which shows the users (that is to say, the members) belonging to each group prior to the input of the context, and a list which shows the users belonging to each group after the input of the context and the users leave and/or join each group based on that context. The ember list differences include at least one of information to represent a group which the user identified by the user identifier included in the context has left, and information to represent the leave from that group, and information to represent a group which that user has joined, and information to represent the joining in that group. The Joining/leave determining unit 915 transmits the generated information to represent member list differences, to a member list difference receiving unit 972 of the member list difference receiving apparatus 97.

Patent literature 1 discloses an electro-optical apparatus which has pixel parts that are arranged in a matrix shape and a drive means to drive these pixel parts, and which further has a comparison means that compares the driving state of the electro-optical apparatus at the first point in time and the driving state of the electro-optical apparatus at a second point in time later than the first time point, and that outputs a difference signal which represents the differences in the driving state between the first time point and the second time point.

Patent literature 2 discloses a user context clustering system for a customer self-service system, which deduces user context to resemble the referenced user context, in the user context managed by a database provided in the customer self-service system. This system has a context attribute database, which contains the attributes of context such as the types of user context, and performs clustering based on distances calculated per context attribute.

Patent literature 3 discloses an analysis scheme for basket analysis, which analyzes the combination of products to be purchased together, and which, by selecting an analysis process target from the combination to match predetermined conditions using a cache algorithm, prevent the processing speed from decreasing even when the number of processing targets increases.

Patent literature 4 discloses a group management apparatus that detects the location of an information processing apparatus, and that, when user authorization succeeds after the detected location is determined to be in a predetermined range, notifies the encryption key to be used in communication with a certain group, to that information processing apparatus. That is to say, upon forming a secure information sharing group, this group management apparatus is able to automatically deliver the encryption key to use to join that group and to communicate with that group.

Patent literature 5 discloses a document management system, which, in the event, after a predetermined document is searched for using an attribute value of the document as a search key, the attribute value of the predetermined document changes, can present a search condition for searching for a document having that changed attribute value.

Patent literature 6 discloses a search apparatus which increases the speed of search process for extracting desired data from a data list. This search apparatus extracts information to represent the place where raw data is stored, by calculating a hush value of a search key and referencing the place corresponding to that hush value in the index area. Next, this search apparatus extracts the desired raw data by referencing the storage place represented by the extracted information in the raw data area. Consequently, since file operation, input and output with respect to a plurality of data files are not performed, it is possible to improve the efficiency and speed of search.

Patent literature 7 discloses a grouping method to divide a set of a certain number of individual entities to be the target of grouping, into a plurality of groups of designated capacity. This grouping method focuses on two individual attributes, out of many individual attributes representing the characteristics of individual entities. This grouping method creates a division table, in which one individual entity frequency unit, which corresponds to a combination of content of these individual attributes, is represented as a unit, which is the minimum unit, creates a grouping template, in which units are distributed to each group of designated capacity, and performs grouping by allocating individual entities to each group based on this grouping template.

### PRIOR ART LITERATURE

### Patent Literature

Patent Literature 1: Unexamined Japanese Patent Application Kokai Publication No. 2000-089728

Patent Literature 2: Unexamined Japanese Patent Application Kokai Publication No. 2002-351917

Patent Literature 3: Unexamined Japanese Patent Application Kokai Publication No. 2005-285048

Patent Literature 4: Unexamined Japanese Patent Application Kokai Publication No. 2006-060589

Patent Literature 5: Unexamined Japanese Patent Application Kokai Publication No. 2007-156625

Patent Literature 6: Unexamined Japanese Patent Application Kokai Publication No. 2007-241378

Patent Literature 7: Unexamined Japanese Patent Application Kokai Publication No. H08-006795

### Non-Patent Literature

Non-Patent Literature 1: Kentaro Yamazaki, et al., “Fast Dynamic Grouping Using Power Set of Context Attributes,” the Institute of Electronics, Information and Communication Engineers, the Proceedings of the 2009 Society Conference, B-7-15.

### DISCLOSURE OF INVENTION

### Problems to be Solved by the Invention

There is a problem with a grouping system using the grouping method of non-patent literature 1, that, when more group rules match context that is received as input, the time (hereinafter referred to as “required time”) it takes to execute the process (hereinafter referred to as “grouping process”) of generating member list differences using that grouping method becomes longer. Possible reasons of this increase of required time include increased access to the tables managed in the rule storage unit 914 and affiliated group storage unit 917 of FIG. 12.

As a specific example, a case will be described here where context to contain A pieces of attribute information is received as input and where there are n grouping rules to match that context. In this case, in the information search unit 912 of FIG. 12, 2^{A}-1 accesses to the rule storage unit 913 and one access to the affiliated group storage unit 916 are required, and, in the affiliated group updating unit 916, maximum n accesses to the affiliated group storage unit 917 are required, so that maximum n+2^{A} table accesses are required in the grouping process.

That is to say, in a conventional grouping system, the number of table accesses increases by O(n) in accordance with the number of groups n to match context that is received as input. Here, given that the required time for the grouping process increases as the number of table accesses increases, and it therefore naturally follows that the required time of the grouping process becomes longer in accordance with the number of group rules n (that is to say, the number of groups) to match context that is received as input.

Likewise, the technologies disclosed in patent literatures 1 to 7 cannot shorten the required time of the grouping process.

The present invention is made in view of the above backgrounds, and it is therefore an object of the present invention to provide a grouping apparatus, a computer-readable recording medium, and a grouping method, that can make the time required to execute the grouping process, which is the process of placing a plurality of users in a plurality of groups according to the individual states, and which involves generating member list differences representing differences in the member list of each group, produced by change of a given user's state, and that can reduce the increase of the time required to execute that process, even if the number of groups where the member list changes due to change of the user's state.

### Means for Solving the Problems

To achieve the above object, a grouping apparatus according to the first aspect of the present invention is a grouping apparatus to allow a user to join or leave one or more groups according to the state of the user, and this grouping apparatus includes:
a change storage unit that associates and stores a key, which is generated based on a first attribute value to represent the state of the user at a first time point and a second attribute value to represent the state at a second time point, which is later than the first time point, and a member list difference, which shows a difference, between the first time point and the second time point, in a list of members belonging to a group which the user is allowed to join or leave, as the state of the user changes from the state at the first time point to the state at the second time point;
an acquisition unit that acquires two-time-point context, which includes an attribute value to represent an old state of the user and an attribute value to represent a current state of the user;
a search unit that searches for the member list difference corresponding to the key generated based on the attribute value to represent the old state and the attribute value to represent the current state, included in the two-time-point context acquired, from the change storage unit; and
a transmission unit that transmits the searched member list difference.

A grouping program recorded in a computer-readable recording medium according to a second aspect of the present invention is a computer program to allow a user to join or leave one or more groups according to the state of the user, and this grouping program allows a computer to function as:
a change storage unit that associates and stores a key, which is generated based on a first attribute value to represent the state of the user at a first time point and a second attribute value to represent the state at a second time point, which is later than the first time point, and a member list difference, which shows a difference, between the first time point and the second time point, in a list of members belonging to a group which the user is allowed to join or leave, as the state of the user changes from the state at the first time point to the state at the second time point;
an acquisition unit that acquires two-time-point context, which includes an attribute value to represent an old state of the user and an attribute value to represent a current state of the user;
a search unit that searches for the member list difference corresponding to the key generated based on the attribute value to represent the old state and the attribute value to represent the current state, included in the two-time-point context acquired, from the change storage unit; and
a transmission unit that transmits the searched member list difference.

A grouping method according to a third aspect of the present invention is a grouping method to allow a user to join or leave one or more groups according to the state of the user, and this grouping methods includes:
an acquisition step of acquiring two-time-point context, which includes an attribute value to represent an old state of the user and an attribute value to represent a current state of the user;
a search step of searching for, from a change storage unit that associates and stores a key, which is generated based on a first attribute value to represent the state of the user at a first time point and a second attribute value to represent the state at a second time point, which is later than the first time point, and a member list difference, which shows a difference, between the first time point and the second time point, in a list of members belonging to a group which the user is allowed to join or leave, as the state of the user changes from the state at the first time point to the state at the second time point, the member list difference corresponding to the key generated based on the attribute value to represent the old state and the attribute value to represent the current state, included in the two-time-point context acquired; and
a transmission step of transmitting the searched member list difference.

### Advantageous Effects of Invention

According to the present invention, it is possible to provide a grouping apparatus, a computer-readable recording medium, and a grouping method that can make the time required to execute the grouping process shorter than heretofore and that can reduce the increase of the time to be required to execute the grouping process even if the number of groups where the member list changes increases.

### BRIEF DESCRIPTION OF DRAWINGS

FIG. 1(a) is a block diagram illustrating an example of a configuration of a grouping system according to embodiment 1 of the present invention;

FIG. 1(b) is a diagram illustrating an example of a configuration of a key generation unit;

FIG. 1(c) is a diagram illustrating an example of a configuration of an information search unit;

FIG. 2 is a diagram illustrating an example of two-time-point context in embodiment 1;

FIG. 3 is a block diagram illustrating an example of a hardware configuration of a grouping apparatus according to embodiment 1;

FIG. 4 is a flowchart illustrating an example of a change registration process executed by a grouping apparatus according to embodiment 1;

FIG. 5 is a diagram illustrating an example of a change table in embodiment 1;

FIG. 6 is a diagram illustrating an example of a rule table in embodiment 1;

FIG. 7 is a flowchart illustrating an example of a grouping process executed by a grouping apparatus according to embodiment 1;

FIG. 8(a) is a block diagram illustrating an example of a configuration of a grouping system according to embodiment 2 of the present invention;

FIG. 8(b) is a diagram illustrating an example of a configuration of a complementing unit;

FIG. 9 is a diagram illustrating an example of a context difference in embodiment 2;

FIG. 10 is a flowchart illustrating an example of a grouping process executed by a grouping apparatus according to embodiment 2;

FIG. 11 is a diagram illustrating an example of a cache table in embodiment 2; and

FIG. 12 is a block diagram illustrating an example of a configuration of a grouping system related to the present invention.

### MODE FOR CARRYING OUT THE INVENTION

Now, embodiments of the present invention will be described below in detail with reference to the accompanying drawings. Note that the same or equivalent parts will be described using the same codes.

### Embodiment 1

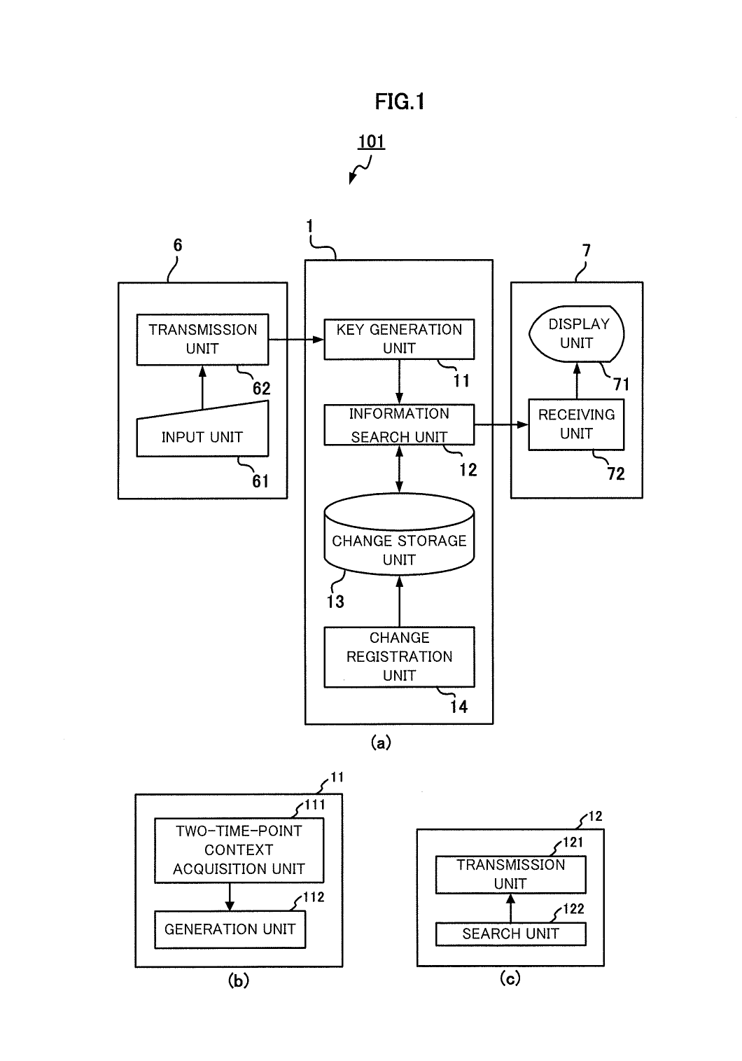

FIG. 1(a) is a block diagram illustrating an example of a configuration of a grouping system according to embodiment 1 of the present invention. A grouping system 101 is a system to place (that is, group) a plurality of users (that is, a plurality of targets subject to grouping) in groups according to the states of the users.

The grouping system 101 is formed with a grouping apparatus 1, a plurality of context transmission apparatuses 6 and a plurality of member list receiving apparatuses 7. The grouping apparatus 1 and the context transmission apparatuses 6 are able to communicate with each other via a network (not illustrated). Likewise, the grouping apparatus 1 and the member list receiving apparatuses 7 are able to communicate with each other via the network.

Note that, although the grouping system 101 has a plurality of context transmission apparatuses 6 and a plurality of member list receiving apparatuses 7 that are each connected to the above network, for ease of explanation, FIG. 1(a) illustrates only one context transmission apparatus 6 and one member list receiving apparatus 7, representing a plurality of context transmission apparatus 6 and member list receiving apparatuses 7, and only these representative context transmission apparatus 6 and member list receiving apparatus 7 will be described below.

Before describing the grouping apparatus 1, the context transmission apparatus 6 and member list receiving apparatus 7 will be described. The context transmission apparatus 6 is a mobile terminal, typified by a mobile telephone, a PDA (Personal Digital Assistant), and a mobile (for example, laptop) personal computer, having a CPU (Central Processing Unit) and a memory.

The context transmission apparatus 6 includes an input unit 61 and a transmission unit 62. The input unit 61 of the context transmission apparatus 6 is formed with a keyboard and a pointing device (hereinafter referred to as “mouse”). The input unit 61 receives as input two-time-point context through operations by the user. The transmission unit 62 transmits two-time-point context that is received as input in the input unit 61, to the grouping apparatus 1.

Here, the two-time-point context refers to information that represents the states, at two different points in time, of the same target that is subject to grouping. The state of a grouping target at a given point in time is represented by the attributes of that target at a given point in time.

According to the present embodiment, the target that is subject to grouping is a user who uses the grouping system 101. Consequently, two-time-point context is formed with a user identifier to identify a given target, and old attribute information and current attribute information of that target. The current attribute information refers to information to represent attribute names and information to represent the current attribute values, and the old attribute information refers to information to represent old attribute values. The two-time-point context includes a plurality of pieces of old attribute information and current attribute values, and the order of arrangement of these old attribute information is the same order as the order of arrangement of current attribute information representing the same types of attribute values.

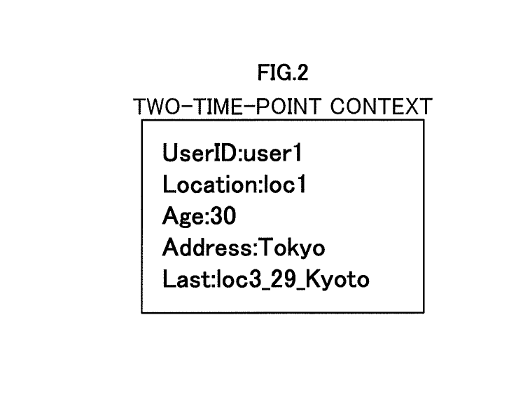

As a specific example, two-time-point context according to the present embodiment will be explained using the two-time-point context “UserID:user1, Location:loc1, Age:30, Address:Tokyo, Last:loc3_{—}29_Kyoto,” illustrated in FIG. 2, as an example. The two-time-point context of FIG. 2 is information to represent the identifier “user1” to identify that user (that is, the target), that user's current state and that user's old state. This user's current state is represented by the attribute value of the user's current age “30” (where the attribute name is “Age”), the attribute value of the user's current location “loc1” (where the attribute name is “Location”), and the attribute value of the user's current address “Tokyo” (where the attribute name is “Address”). Also, information to represent that user's old state is represented by three attribute values that are mutually connected in order by underbars “_.” These three attribute values are the attribute value of the user's age “29” at a given past point in time, the attribute value of the user's location “loc3” at that given past point in time, and the attribute value of the user's address “Kyoto” at that given past point in time. That is to say, the two-time-point context of FIG. 2 represents that the state of the user, who is identified by the identifier “user1,” has changed from an old state of being at the age of “29,” being at the location of “loc3” and living in the address of “Kyoto” to the current state of currently being at the age of “30,” being at the location of “loc1” and living in the address of “Tokyo.”

Note that the input unit 61 may be formed with a sound/voice input apparatus, and may receive as input sound/voice produced by the user, generate a character sequence representing the sound/voice received as input, and generate two-time-point context based on the character sequence generated. Also, the input unit 61 may further include a GPS (Global Positioning System) receiving apparatus, detect the location of the GPS receiving apparatus based on a GPS signal received in the GPS receiving apparatus, and generate two-time-point context using the detected location as the user's current location.

The member list receiving apparatus 7 of FIG. 1(a) is a general (for example, desktop) personal computer having a CPU, a memory, a hard disc apparatus and so on. Note that the member list receiving apparatus 7 may be a server device or a mobile terminal.

The member list receiving apparatus 7 has, for example, a display unit 71 and a receiving unit 72, as illustrated in FIG. 1(a). The display unit 71 is formed with a CRT (Cathode Ray Tube), an LCD (Liquid Crystal Display), or an organic EL (Electro-Luminescence) panel. The receiving unit 72 is formed with a network terminating apparatus or a radio communication apparatus that is connected to the network, and a serial interface or a LAN (Local Area Network) interface connected with these. The display unit 71 displays information that is received in the receiving unit 72 from the grouping apparatus 1.

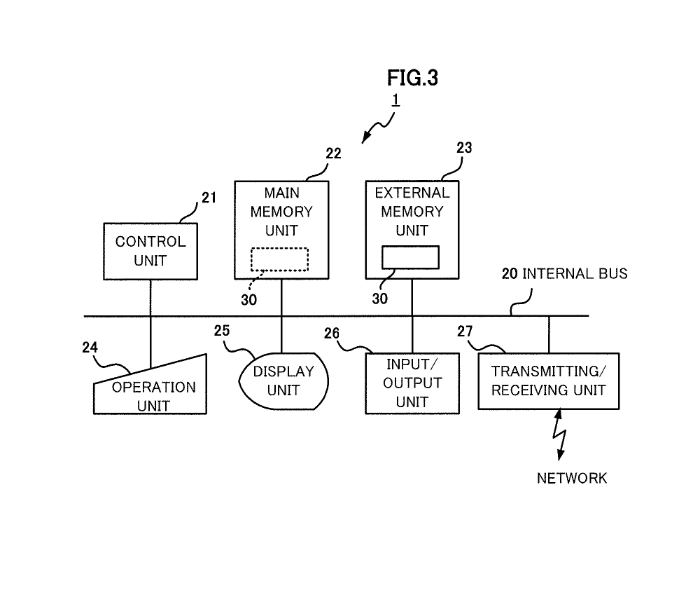

FIG. 3 is a block diagram illustrating an example of a hardware configuration of the grouping apparatus 1 according to an embodiment of the present invention. The grouping apparatus 1 constituting the grouping system 101 is a general server device. However, this is by no means limiting, and the grouping apparatus 1 may be a personal computer or a mobile terminal.

As illustrated in FIG. 3, the grouping apparatus 1 has a control unit 21, a main storage unit 22, an external storage unit 23, an operation unit 24, a display unit 25, an input/output unit 26, and a transmitting/receiving unit 27. The main storage unit 22, external storage unit 23, operation unit 24, display unit 25, input/output unit 26, and transmitting/receiving unit 27 are each connected to the control unit 21 via an internal bus 20.

The control unit 21 is formed with a CPU (Central Processing Unit) and so on, and executes processes to implement the key generation unit 11, information search unit 12, and change registration unit 14 of the grouping apparatus 1 illustrated in FIG. 1(a), following a control program 30 stored in the external storage unit 23.

The main storage unit 22 is formed with a RAM (Random-Access Memory) and so on, and, by loading the control program 30 stored in the external storage unit 23, is used as the work area of the control unit 21.

The external storage unit 23 is formed with a non-volatile memory such as a flash memory, a hard disc, a DVD-RAM (Digital Versatile Disc Random-Access Memory), a DVD-RW (Digital Versatile Disc ReWritable) and so on, and stores a program for allowing the control unit 21 to perform the processes in the grouping system 101. Also, following a command from the control unit 21 executing this program, the external storage unit 23 supplies data to be used to execute this program, to the control unit 21, and stores the data supplied from the control unit 21.

The operation unit 24 is formed with a keyboard and a pointing device such as a mouse, and an interface apparatus that connects the keyboard and pointing device or the like to the internal bus 20.

The display unit 25 is formed with a CRT (Cathode Ray Tube), an LCD (Liquid Crystal Display), or an organic EL (Electro-Luminescence) panel. The input/output unit 26 is formed with a serial interface or a parallel interface. The transmitting/receiving unit 27 is formed with a network terminating apparatus or a radio communication apparatus to be connected to the network, and a serial interface or LAN (Local Area Network) interface connected to these. The transmitting/receiving unit 27 connects with the context transmission apparatus 6 and member list receiving apparatus 7 of FIG. 1(a) via a network (not illustrated).

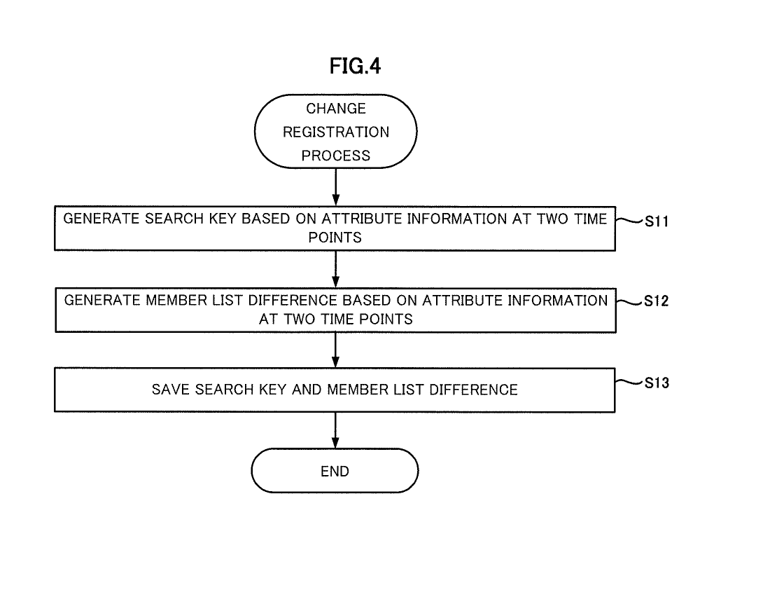

By executing the change registration process such as illustrated in FIG. 4 using hardware resources such as the main storage unit 22, external storage unit 23, operation unit 24, display unit 25, input/output unit 26 and transmitting/receiving unit 27, the control unit 21 of FIG. 3 functions as the change registration unit 14 illustrated in FIG. 1(a). Also, by cooperating with the external storage unit 23 of FIG. 3, the control unit 21 function as the change storage unit 13 illustrated in FIG. 1(a).

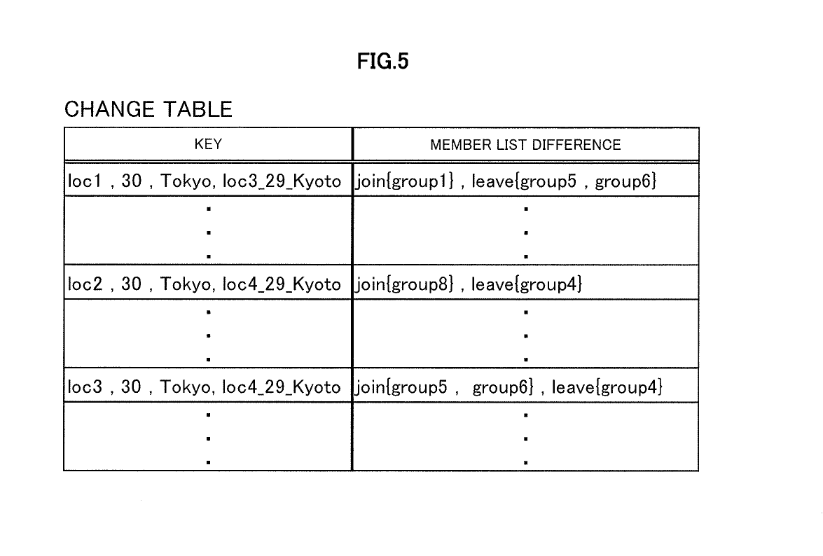

The change storage unit 13 furthermore stores the rule table illustrated in FIG. 5. This rule table associates and stores a grouping rule ID to identify a grouping rule, group identification information to identify the group which a user who is in a state to fulfill the grouping condition defined by the grouping rule belongs to (or joins), and information to represent the grouping condition to be applied to the attribute value of the user belonging to that group. Such a grouping condition is represented by one or more attribute values representing the state to fulfill that condition. Note that a grouping condition may be represented by the attribute name of one or more attributes to represent the state fulfilling that condition, and an attribute value to fulfill that condition.

As a specific example, a case will be described here where the grouping condition to be defined by the grouping rule of group 10, which is identified by “group 10,” is “loc1,30,Tokyo” (that is, the user is currently in the state of being located at “loc1,” being “30” years old, and living in “Tokyo”). Context of a user who is in a state to fulfill the above condition includes current attribute information, which represents that the current value of the attribute of the attribute name “Location” (that is, the current attribute value) is “loc1,” current attribute information, which represents that the current value of the attribute of the attribute name “Age” is “30,” and current attribute information, which represents the current value of the attribute of the attribute name “Address” is “Tokyo.” Such context is referred to as context to fit (that is, match) that grouping rule. By contrast with this, context to miss just one of these three pieces of current attribute information is referred to as unfit context with respect to that grouping rule.

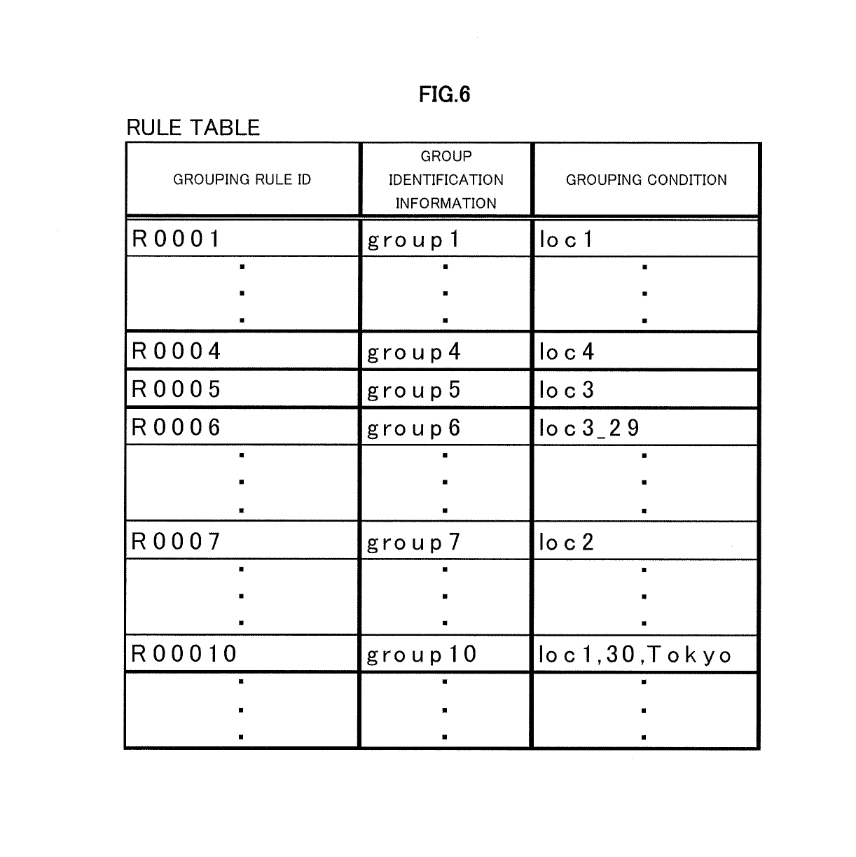

The change storage unit 13 stores the change table illustrated in FIG. 6. The change table associates and stores a search key that is generated based on attribute information at two given points in time, and information that represents member list differences in accordance with the attribute information at the two points in time. Note that the member list differences in accordance with attribute information at two time points refers to differences in the member list showing the users (that is to say, members) belonging to each group between the two time points, and refers to member list differences produced by user state changes represented by that attribute information at two time points.

That is to say, a difference in the member list produced by user state changes represented by attribute information at two time points is produced when an attribute value to represent a given user's state fulfills the condition defined by the group rule and therefore that user joins the group where the joining condition is defined by that group rule, or is produced when that attribute value no longer fulfills the condition and therefore that user leaves the group.

Consequently, the member list difference in accordance with attribute information at two time points is represented by at least one of group identification information of a group which the user joins and information “join” which represents that the user joins that group, as illustrated in FIG. 6, and group identification information of a group which the user leaves and information “leave” which represents that the user leaves that group.

As a specific example, a case will be described here where a given user's state—that is, a state which is represented by old attribute information included in given context and a state which does not fulfill the grouping condition defined by the grouping rule of group 1—changes to the state which is represented by the current attribute information included in that context and which fulfills the grouping condition. The member list difference in accordance with the two-time-point attribute information included in this context represents the difference between the members of group 1 at the old time point and the members of group 1 at present (that is to say, the joining of that user in group 1) by “join{group1}”.

On the other hand, in the event a given user's state—that is, a state which is represented by old attribute information and a state which fulfills the grouping condition of group 1—changes to the state which is represented by the current attribute information and which does not fulfill the grouping condition, the member list difference in accordance with the two-time-point attribute information represents the leave from group 1 by “leave{group1}.”

As specific examples, the rule table of FIG. 5 and the change table of FIG. 6 will be explained. The member list difference associated with the key “loc1,30,Tokyo,loc3_{—}29_Kyoto” in FIG. 6 is “join{group1},leave{group5,group6}.” This means that, when a given user's state changes from a state of being located at “loc3,” being at the age of “29” and having an address in “Kyoto,” to a state of being located at “loc1,” being at the age of “30” and having an address in “Tokyo,” that user leaves group 5 and group 6 and joins group 1.

This is because the grouping condition defined by the grouping rule of group 5 illustrated in FIG. 5 is “loc3,” and because, in order to allow the user to belong to group 5, the user's state must fulfill at least the condition of assuming the state of being located at “loc3.” Similarly, this is because the grouping condition defined by the grouping rule of group 6 illustrated in FIG. 5 is “loc3 29,” and because, in order to allow the user to belong to group 6, the user's state must fulfill at least the condition of assuming the state of being located at “loc3” and being “29” years old. Given these, when a given user's state changes from the state of being located at “loc3” and being at the age of “29,” to the state of being located at “loc1” and being at the age of “30,” that user leaves group 5 and group 6.

Likewise, since the grouping condition defined by the grouping rule of group 1 in FIG. 5 is “loc1,” in order to allow the user to belong to group 1, the user's state must fulfill at least the condition of assuming the state of being located at “loc1.” Consequently, when a given user's state changes from the state of being located at “loc3” to the state of being located at “loc1,” that user joins group 1. Note that that user's current state does not fulfill other grouping conditions and therefore the user does not join other groups besides group 1.

Likewise, the member list difference associated with the key “loc2,30,Tokyo,loc4_{—}29_Kyoto” in FIG. 6 is “join{group8},leave{group4}.” This means that, when a given user's state changes from a state of being located at “loc4,” being at the age of “29” and having an address in “Kyoto,” to a state of being located at “loc2,” being at the age of “30” and having an address in “Tokyo,” that user leaves group 4 and joins group 8.

Furthermore, likewise, the member list difference associated with the key “loc3,30,Tokyo,loc4_{—}29_Kyoto” in FIG. 6 is “join{group5,group6},leave{group4}.” This means that, when a given user's state changes from a state of being located at “loc4,” being at the age of “29” and having an address in “Kyoto,” to a state of being located at “loc3,” being at the age of “30” and having an address in “Tokyo,” that user joins group 5 and group 6 and leaves group 4.

When the change registration process of FIG. 4 is started, the change registration unit 14 specifies all combinations of a plurality of attributes designated by the grouping condition, and, with respect to all of the specified combinations of attributes, specifies possible changes of attribute values, within a predetermined range of attribute values. Note that information to represent a plurality of attributes designated by the grouping condition and information to represent the predetermined range of attribute values are stored in advance in the change storage unit 13 of FIG. 1(a).

Here, given that the attribute name “Age” is the attribute to represent the user's age, possible attribute value changes that might occur to the attribute of the attribute name “Age” cover change from the attribute value “29” to “30,” but do not cover change from the attribute value “30” to “29.” Likewise, in the event there is a restriction, with respect to attribute information to represent the location, that move from location “loc3” to “loc1” is possible but nevertheless move from “loc3” to “loc1” without passing “loc1” is not possible, changes of that attribute value cover change from the attribute value “loc3” to “loc1,” but do not cover change from the attribute value “loc3” to “loc2.” In this way, in accordance with restrictions determined by the types of attributes, the change registration unit 14 specifies changes of attribute values that might occur in these attributes, and generate keys to match the specified changes of attribute values.

After that, for all changes specified with respect to all combinations of attributes and the attributes of these combinations, the change registration unit 14 generates attribute information at time points before and after changes (that is, at two time points), and generates search keys based on the generated attribute information of two time points (step S11). As a specific example, based on the attribute information of two time points illustrated in FIG. 2, the search key “loc1,Tokyo,30,loc3_{—}29_Kyoto,” in which attribute values are connected by commas, is generated.

Next, the change registration unit 14 generates member list differences, which represent changes to be produced in the member list of each group by change of attribute values represented by the attribute information of two time points (step S12). After that, the change registration unit 14 associates the generated search keys and information to represent the generated member list differences, and, after having registered these with the change table of FIG. 6 stored in the change storage unit 13 (step S12), finishes executing the change registration process.

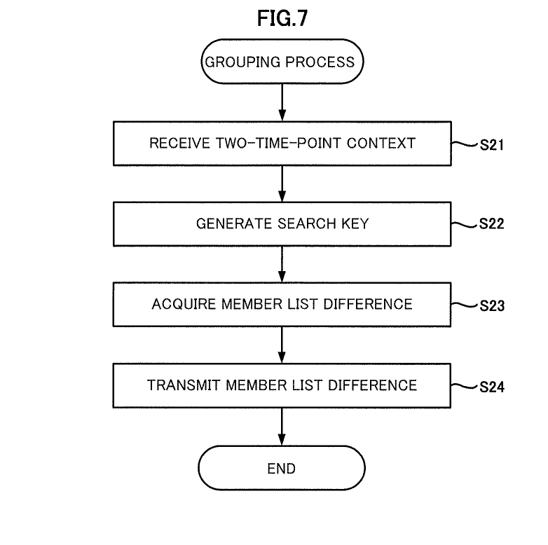

By executing the grouping process illustrated in FIG. 7 using hardware resources such as the main storage unit 22, external storage unit 23, operation unit 24, display unit 25, input/output unit 26, and transmitting/receiving unit 27, the control unit 21 of FIG. 3 functions as the key generation unit 11 and information search unit 12 illustrated in FIG. 1.

Note that the grouping process refers to the process of placing a plurality of users in a plurality of groups according to their individual states and generating member list differences, which represent the differences that are produced in the member list of each groups by change of a given user's state. That is to say, the grouping process refers to the process of comparing preregistered conditions of belonging to groups (that is, grouping conditions) and two-time-point context of a given target that is received as input, to specify a group which the target has newly joined and a group the target has left, and output the difference in the member list of each group before and after input of context, based on the specified result.

Upon starting the grouping process of FIG. 7, the two-time-point context unit 111 of the key generation unit 11 illustrated in FIG. 1(b) receives two-time-point context from the context transmission apparatus 6 (step S21). Next, the generation unit 112 of the key generation unit 11 illustrated in FIG. 1(b) generates a search key to be used to search for the member list difference to match the current attribute information and old attribute information (that is, attribute information of two time points) included in the two-time-point context that is received, from the change table of FIG. 6 (step S22), and transmits the generated key to the information search unit 12.

The search unit 122 of the information search unit 12 illustrated in FIG. 1(c) acquires the member list difference to match the received search key, from the change table of the change storage unit 13 (step S23). The acquired member list difference shows the difference between a list (hereinafter referred to as “member list”) which shows the users (that is, the members) belonging to each group before context is received in step S21, and the member list of each group after that context is received and the user identified by the user identifier included in that context leaves and/or joins each group.

After step S23, the transmission unit 121 of the information search unit 12 illustrated in FIG. 1(c) transmits information to represent the acquired member list difference to the member list receiving apparatus 7 (step S24), and, after that, finishes executing the grouping process. Note that the member list receiving apparatus 7 displays the member list difference represented by the received information, on a display unit 71.

As described above, although a conventional system requires maximum n+2^{A} (where “n” is the number of grouping rules and “A” is the number of attributes) table accesses in order to execute the conventional grouping process, with the grouping system 101 of embodiment 1, the grouping process can be executed by only one table access by the information search unit 12 to the change table stored in the change storage unit 1. By this means, it is possible to make the time required to execute the grouping process shorter than heretofore. Also, since the number of table accesses does not depend on the number of grouping rules or the number of attributes A, even if the number of group rules (that is, the number of groups) to match (that is, fit) context that is received as input increases, it is still possible to reduce the increase of the processing time. In particular, the time it takes to execute the grouping process becomes substantially constant.

### Embodiment 2

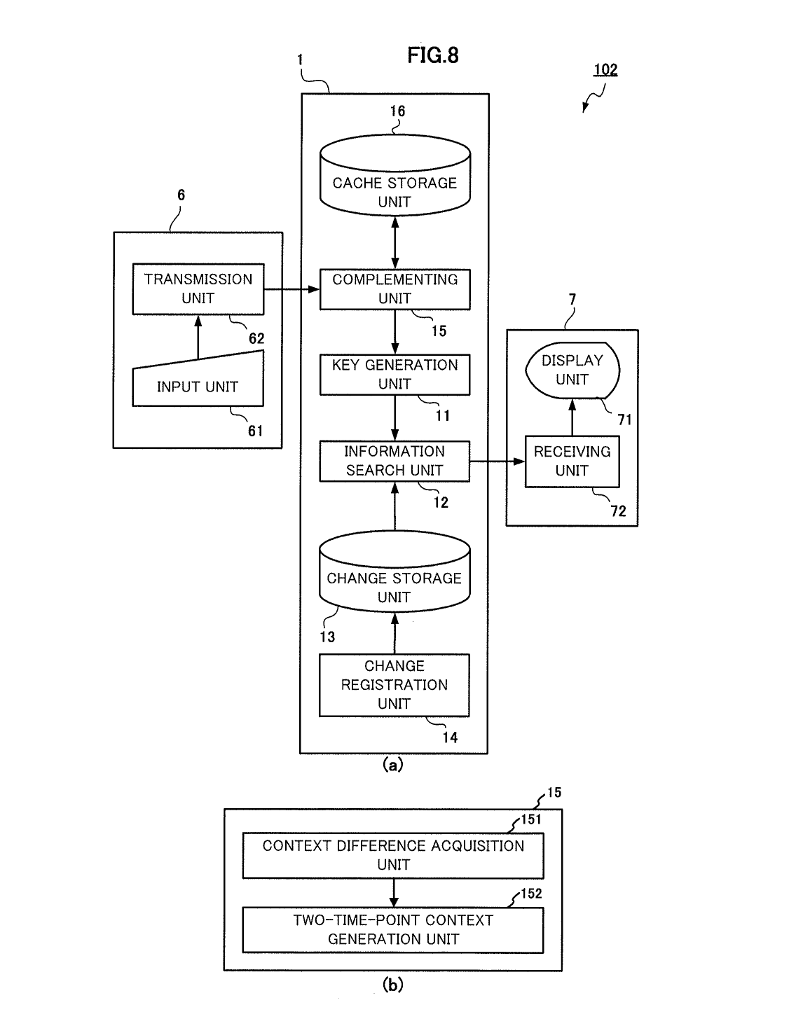

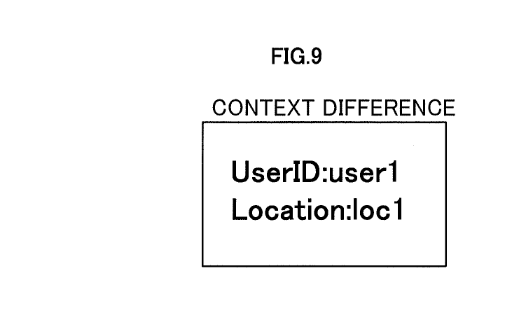

Next, a grouping system 102 according to embodiment 2 of the present invention will be described with reference to FIG. 8. The input unit 61 of the context transmission apparatus 6 according to embodiment 2 receives as input the context difference illustrated in FIG. 9. After that, the transmission unit 62 of the context transmission apparatus 6 transmits the context difference received as input in the input unit 61, to the grouping apparatus 1.

The context difference includes the user identifier to identify the user and attribute information to represent an attribute value that is different from the attribute value represented by the attribute information included in the context difference of the user previously received as input. That is to say, the context difference is the user's current state and represents a state that is different from the state represented by the previously input context difference. As a specific example, after the context difference of the user identified by the user identifier “user1” was previously received as input, if the user has moved from the location “loc3” to the location “loc1,” has stayed at the address in “Kyoto” and has not aged from the age of “30,” the context difference illustrated in FIG. 9, which includes the user identifier “user1” of that user and attribute information to represent the location “loc3,” is received as input (however, attribute information to represent the age “30” and attribute information to represent the address “Kyoto” are not included).

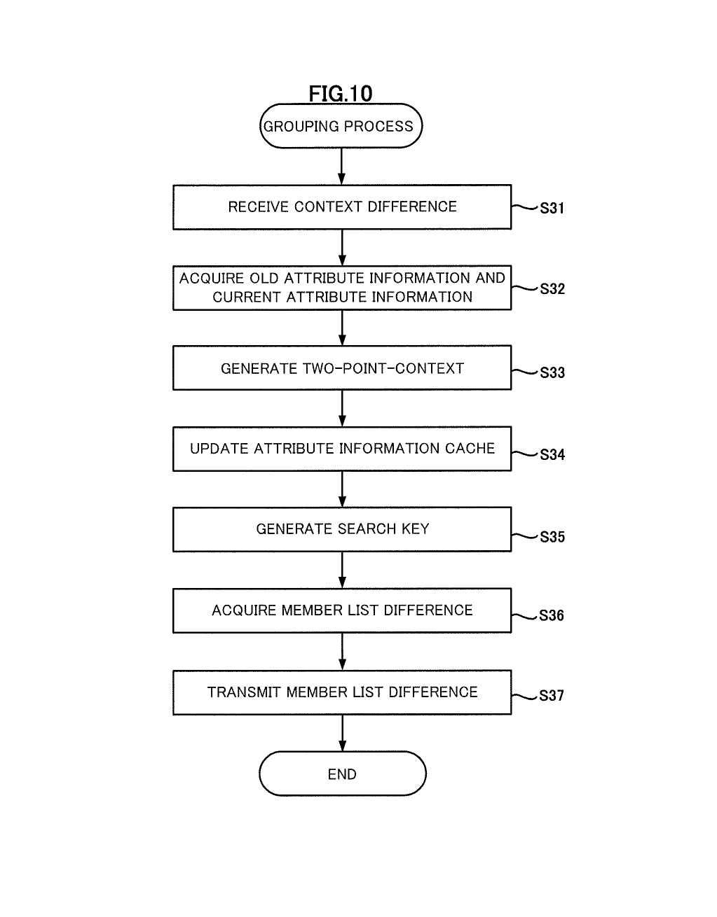

Using the hardware resources of FIG. 3, the control unit 21 of FIG. 3 executes the group process illustrated in FIG. 10, there by functioning as each function block illustrated in

FIG. 1 and also functioning as the complementing unit 15 of FIG. 15. Also, by cooperating with the external storage unit 23 of FIG. 3, the control unit 21 functions as the context storage unit 16 of FIG. 15.

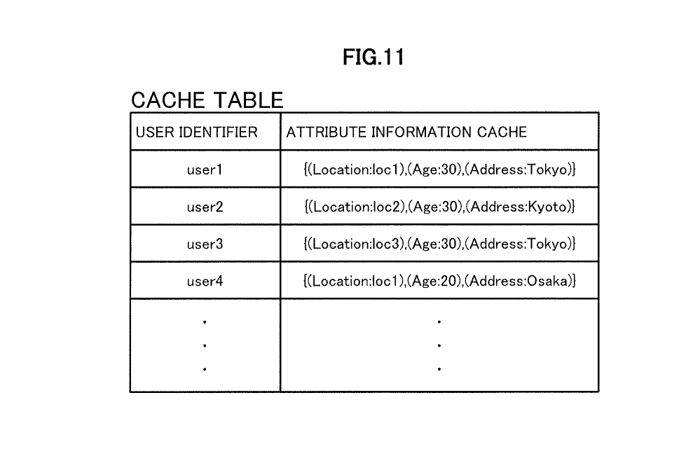

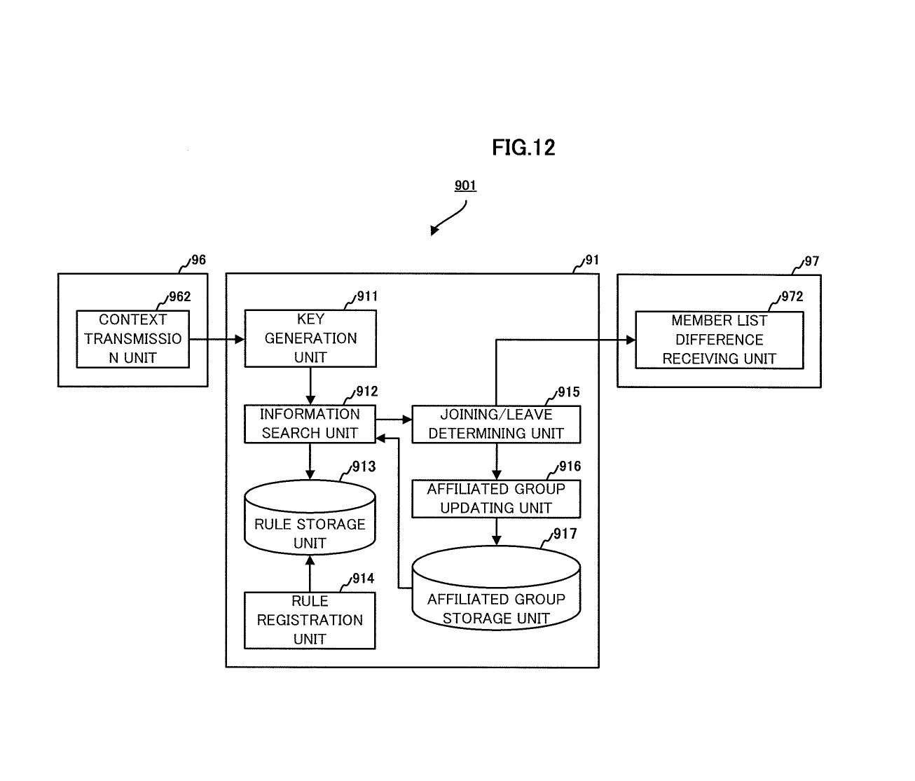

The context storage unit 16 furthermore stores the cache table illustrated in FIG. 11.

This cache table caches a plurality of pieces of information associating user identifiers to identify users and the users' latest attribute information received in the grouping apparatus 1.

Upon starting the group process of FIG. 10, the context difference acquisition unit 151 of the complementing unit 15 illustrated in FIG. 8(b) receives a context difference from the context transmission apparatus 6 (step S31). Next, the two-time-point context generation unit 152 of the complementing unit 15 illustrated in FIG. 8(b) uses the user identifier included in the received context difference as a search key, and acquires the attribute information cache associated with that user identifier (that is, old attribute information) from the context storage unit 16 (step S32). After that, the two-time-point context generation unit 152 generates the two-time-point context illustrated in FIG. 2 based on the received context difference and the acquired attribute information cache (step S33).

After that, the complementing unit 15 associates and stores the current attribute information included in the generated two-time-point context, with the user identifier included in that two-time-point context, and have these stored in the cache table of FIG. 1, thereby updating the attribute information cache (step S34). By associating and storing the attribute information cache with information to represent the time that attribute information cache is received, or the time that attribute information cache is saved, the complementing unit 15 may accumulate these in the manner of time sequence in the context storage unit 16.

As a specific example, a case will be described here where the context difference acquisition unit 151 of the complementing unit 15 illustrated in FIG. 8(a) acquires a context difference including the user identifier “user1.” When the context difference is acquired in the context difference acquisition unit 151, the two-time-point context generation unit 152 of the complementing unit 15 illustrated in FIG. 8(b) acquires the attribute information cache “{(Location:loc3), (Age:30), (Address:Tokyo)}” associated with the user identifier “user1,” from the cache table of FIG. 11, and generates the old attribute information “loc3_{—}30_Tokyo,” by connecting the attribute values “loc3,” “30,” and “Tokyo,” represented by the attribute information included in the acquired attribute information cache, with underbars “_” in order.

Next, the two-time-point context generation unit 152 acquires the attribute name “Location” from the context difference, and acquires one or a plurality of pieces of attribute information other than attribute information including that attribute name (that is to say, (Age:30) and (Address:Tokyo)) from the attribute information cache , and add that acquired attribute information to the attribute information included in the context difference, and, by adding the acquired attribute information to the attribute information included in the context difference, generates one or a plurality of pieces of attribute information to represent the current state of the user identified by “user3.” That is to say, based on the context difference “{user1,(Location,loc1)” and the attribute information cache “{(Location:loc3), (Age:30), (Address:Tokyo)},” the old attribute information “{(last:loc3_{—}30_Tokyo)}” and current attribute information “{(Location:loc1), (Age:30), (Address:Tokyo)}” are generated. The two-time-point context generation unit 152 generates the two-time-point context “{user1, (Location:loc3), (Age:30), (Address:Tokyo), (last:loc3_{—}30_Tokyo)},” based on the generated old attribute information and current attribute information. After that, the two-time-point context generation unit 152 overwrites and saves the current attribute information “{(Location:loc3), (Age:30), (Address:Tokyo)},” as the attribute information cache associated with the user identifier “user1” in the context storage unit 16, in the cache table of FIG. 11, thereby updating the attribute information cache.

After step S34 of FIG. 10, the two-time-point context generation unit 152 transmits the generated two-time-point context to the two-time-point context acquisition unit 111 of the key generation unit 11. After having executed the processes (step S35 to S37) that are the same as steps S22 to S24 in FIG. 7, the key generation unit 11 and the information search unit 12 finish executing the grouping process.

As described above, according to the grouping system 102 of embodiment 2, it is possible to perform the grouping process in a shorter time than heretofore, even in the event of using context differences as input information. With the grouping system 102 of embodiment 2, in addition to one table access to the change table stored in the change storage unit 13 by the information search unit 12, two table accesses are required to acquire and update the user attribute information cache stored in the context storage unit 16, and it is therefore possible to implement the grouping process by total three table accesses.

Consequently, similar to the grouping system 101 according to embodiment 1, with the grouping system 102 according to embodiment 2, it is possible to make the time required to execute the grouping process shorter than heretofore, and, in addition, it is still possible to reduce the increase of the processing time even if the number of group rules (that is, the number of groups) to match (that is, fit) two-time-point context generated based input context differences increases. In particular, the time it takes to execute the grouping process becomes substantially constant.

Note that the context transmission apparatus 6 of FIG. 1 or FIG. 8 may be part of the grouping apparatus 1 or may be an apparatus attached to the grouping apparatus 1. In the configuration in which the context transmission apparatus 6 is included in the grouping apparatus 1, the operation unit 24 of FIG. 3 might function as the input unit 61 of the context transmission apparatus 6. In this case, for example, in the event of setting the rules of grouping (that is, grouping rules), the display unit 25 of FIG. 3 displays a predetermined operation screen, and the user, visually recognizing this operation screen, operates the operation unit 24. By this means, commands to set grouping rules are supplied to the control unit 21 via the operation unit 24. Also, in the event the context transmission apparatus 6 is an apparatus that is attached to the grouping apparatus 1, the input/output unit 26 of FIG. 3 connects with the context transmission apparatus 6.

Likewise, the member list receiving apparatus 7 of FIG. 1 or FIG. 8 may be part of the grouping apparatus 1 or may be an apparatus to be attached to the grouping apparatus 1. In the configuration in which the member list receiving apparatus 7 is included in the grouping apparatus 1, the display unit 25 of FIG. 3 might function as the display unit 61 of the member list receiving apparatus 7. Also, in the event the member list receiving apparatus 7 is an apparatus to be attached to the grouping apparatus 1, the input/output unit 26 of FIG. 3 connects with the member list receiving apparatus 7.

Part or the entirety of the above embodiment 1 and embodiment 2 may be described as in the following additional notes, but are by no means limited to the following:

(Additional Note 1)

A grouping apparatus that allows a user to join or leave one or more groups according to a state of the user, the grouping apparatus including:
a change storage unit that associates and stores a key, which is generated based on a first attribute value to represent the state of the user at a first time point and a second attribute value to represent the state at a second time point, which is later than the first time point, and a member list difference, which shows a difference, between the first time point and the second time point, in a list of members belonging to a group which the user is allowed to join or leave, as the state of the user changes from the state at the first time point to the state at the second time point;
an acquisition unit that acquires two-time-point context, which includes an attribute value to represent an old state of the user and an attribute value to represent a current state of the user;
a search unit that searches for the member list difference corresponding to the key generated based on the attribute value to represent the old state and the attribute value to represent the current state, included in the two-time-point context acquired, from the change storage unit; and
a transmission unit that transmits the searched member list difference.

(Additional Note 2)

The grouping apparatus as defined in additional note 1, in which:
amongst a plurality of attribute values representing a plurality of states of the user respectively, the acquisition unit acquires an attribute value which represents a state having changed after the attribute values of the user were previously acquired;
the grouping apparatus further includes:
a cache storage unit that caches the attribute values of the user that were previously acquired in the acquisition unit; and
a context generation unit that, based on attribute values, which are currently acquired in the acquisition unit and which represent a changed state of the user, and attribute values, which were previously acquired and cached in the cache memory unit and which represent the state of the user, generates two-time-point context, which includes a plurality of attribute values to represent a plurality of current states of the user, and a plurality of attribute values to represent a plurality of old states of the user; and
the acquisition unit acquires the two-time-point context generated in the context generation unit.

(Additional Note 3)

The grouping apparatus as defined in one of additional note 1 or additional note 2, further including a registration unit that, after the key is generated based on the first attribute value and the second attribute value, associates and registers, in the change storage unit, the generated key and the member list difference, which shows the difference, between the first time point and the second time point, in the list of members belonging to the group which the user is allowed to join or leave, as the state of the user changes from the state at the first time point to the state at the second time point,
in which the registration unit generates the search key with respect to a combination of the first attribute value and the second attribute value to match a restriction that is determined by a characteristic of a state represented by the first attribute value and the second attribute value.

(Additional Note 4)

A computer readable recording medium in which a grouping program to allow a user to join or leave one or more groups according to a state of the user is recorded, the grouping program allowing a computer to function as:
a change storage unit that associates and stores a key, which is generated based on a first attribute value to represent the state of the user at a first time point and a second attribute value to represent the state at a second time point, which is later than the first time point, and a member list difference, which shows a difference, between the first time point and the second time point, in a list of members belonging to a group which the user is allowed to join or leave, as the state of the user changes from the state at the first time point to the state at the second time point;
an acquisition unit that acquires two-time-point context, which includes an attribute value to represent an old state of the user and an attribute value to represent a current state of the user;
a search unit that searches for the member list difference corresponding to the key generated based on the attribute value to represent the old state and the attribute value to represent the current state, included in the two-time-point context acquired, from the change storage unit; and
a transmission unit that transmits the searched member list difference.

(Additional Note 5)

A grouping method to allow a user to join or leave one or more groups according to a state of the user, the grouping method including:
an acquisition step of acquiring two-time-point context, which includes an attribute value to represent an old state of the user and an attribute value to represent a current state of the user;
a search step of searching for, from a change storage unit that associates and stores a key, which is generated based on a first attribute value to represent the state of the user at a first time point and a second attribute value to represent the state at a second time point, which is later than the first time point, and a member list difference, which shows a difference, between the first time point and the second time point, in a list of members belonging to a group which the user is allowed to join or leave, as the state of the user changes from the state at the first time point to the state at the second time point, the member list difference corresponding to the key generated based on the attribute value to represent the old state and the attribute value to represent the current state, included in the two-time-point context acquired; and
a transmission step of transmitting the searched member list difference.

(Additional Note 6)

A grouping system including:
a storage unit that stores, in association with a key that is generated based on attribute information formed with an attribute name and an attribute name at two time points, a member list difference that shows match or mismatch with a predetermined grouping rule due to change form old attribute information to current attribute information;
an acquisition unit that acquires two-time-point context including old attribute information and current attribute information of a search target;
a generation unit that generates a search key for searching for the member list difference based on the two-time-point context;
a search unit that searches for and acquires the member list difference corresponding to the search key from the storage unit; and
a presenting unit that presents the member list difference acquired in the search unit to the user.

(Additional Note 7)

The grouping system as defined in additional note 6, further including a cache storage unit that stores attribute information of the search target as attribute information cache, in which the acquisition unit includes:
an acquisition unit that acquires a context difference including current attribute information in which the search target has changed;
a cache search unit that searches for the attribute information corresponding to the context difference, from the cache storage unit, as old attribute information of the search target; and
a context generation unit that generates the two-time-point context, based on the old attribute information of the search target acquired by the cache search unit, and the current attribute information of the search target included in the context difference.

(Additional Note 8)

The grouping system as defined in one of additional note 6 or additional note 7, in which the generation unit generates the search key so as to match the restriction determined by the characteristic of the attribute information.

(Additional Note 9)

A grouping method to be executed by a grouping system, the grouping method including:
an acquisition step of acquiring two-time-point context including old attribute information and current attribute information of a search target;
a generation step of generating a search key for searching for a member list difference that shows match or mismatch with a predetermined grouping rule due to change form old attribute information to current attribute information, based on the two-time-point context;
a search step of searching for and acquiring the member list difference corresponding to the search key, from a storage unit that stores the member list difference in association with the key generated based on attribute information of two time points; and
a presenting step of presenting the member list difference acquired in the search unit to the user.

(Additional Note 10)

The grouping method as defined in additional note 9, in which the acquisition step includes:
an acquisition step of acquiring a context difference including current attribute information in which the search target has changed;
a cache search step of searching for the attribute information corresponding to the context difference, from a cache storage unit that stores attribute information of the search target as attribute information cache, as old attribute information of the search target; and
a context generation step of generating the two-time-point context, based on the old attribute information of the search target acquired in the cache search step, and the current attribute information of the search target included in the context difference.

(Additional Note 11)

The grouping method as defined in one of additional note 9 or additional note 10, in which, in the generation step, the search key is generated so as to match the restriction determined by the characteristic of the attribute information.

(Additional Note 12)

A program to allow a computer to execute:
an acquisition step of acquiring two-time-point context including old attribute information and current attribute information of a search target;
a generation step of generating a search key for searching for a member list difference that shows match or mismatch with a predetermined grouping rule due to change form old attribute information to current attribute information, based on the two-time-point context;
a search step of searching for and acquiring the member list difference corresponding to the search key, from a storage unit that stores the member list difference in association with the key generated based on attribute information of two time points; and
a presenting step of presenting the member list difference acquired in the search unit to the user.

Besides, the above hardware configurations and flowcharts are given only by way of example, and can be changed or corrected on an arbitrary basis. Also, embodiment 1 and embodiment 2 may be combined with each other.

The core part to perform the grouping process, which is formed with the control unit 21, main storage unit 22, external storage unit 23, operation unit 24, internal bus 20 and so on, can be implemented using a general computer system, without relying upon a dedicated system. For example, it is possible to store a computer program for executing the above grouping process in a computer-storage storage medium (for example, a flexible disc, a CD-ROM, a DVD-ROM and so on), distribute this storage medium, and, by installing this computer program in a computer, configure the grouping systems 101 and 102 to execute the above processes. Also, it is equally possible to store the computer program in a storage apparatus provided in a server apparatus on a communication network such as the Internet, and, by downloading this computer program on a general computer system and so on, configure the grouping systems 101 and 102.

Also, in the event dividing and implementing the functions of the grouping systems 101 and 102 between the OS (Operating System) and application program, or in the event of implementing the functions of the grouping systems 101 and 102 by cooperation between the OS and application program, it is possible to store only the application program part in a recording medium or a storage apparatus.

Also, it is equally possible to multiplex a computer program on carrier waves and distribute that computer program via a communication network. For example, it is possible to post the above computer program on a bulletin board (BBS: Bulletin Board System) on a communication network and distribute that computer program via the network. Then, it is possible to provide a configuration in which the above processes are executed by activating this computer program and executing this computer program in the same way as other application programs under the control of the OS.

Furthermore, the present invention may be implemented in various embodiments or modifications without departing the general spirit and scope of the present invention. Also, the above-described embodiments only describe the present invention and by no means limit the scope of the present invention. That is to say, the scope of the present invention is defined by the claims, not the embodiments. Then, various modifications that are made within the scope of the claims and within the equivalent scope of the purpose of the present invention are to be construed to be within the scope of the present invention.

The present application is based on Japanese Patent Application No. 2010-080662, filed on Mar. 31, 2010, and the contents of Japanese Patent Application No. 2010-080662, including the specification, claims, and drawings, are entirely incorporated herein by reference.

### DESCRIPTION OF REFERENCE NUMERALS

1, 91 Grouping apparatus
6, 96 Context transmission apparatus
7, 97 Member list receiving apparatus
11, 911 Key generation unit
12, 912 Information search unit
13 Change storage unit
14 Change registration unit
15 Complementing unit
16 Context storage unit
61 Input unit
62 Transmission unit
71 Display unit
72 Receiving unit
21 Control unit
22 Main storage unit
23 External storage unit
24 Operation unit
25 Display unit
26 Input/output unit
27 Transmitting/receiving unit
30 Control program
101, 102, 901 Grouping system
913 Rule storage unit
914 Rule registration unit
915 Joining/leave determining unit
916 Affiliated group updating unit
917 Affiliated group storage unit
962 Context transmission unit
972 Member list difference receiving unit

1. A grouping apparatus that allows a user to join or leave one or more groups according to a state of the user, the grouping apparatus comprising:
a change storage unit that associates and stores a key, which is generated based on a first attribute value to represent the state of the user at a first time point and a second attribute value to represent the state at a second time point, which is later than the first time point, and a member list difference, which shows a difference, between the first time point and the second time point, in a list of members belonging to a group which the user is allowed to join or leave, as the state of the user changes from the state at the first time point to the state at the second time point;
an acquisition unit that acquires two-time-point context, which includes an attribute value to represent an old state of the user and an attribute value to represent a current state of the user;
a search unit that searches for the member list difference corresponding to the key generated based on the attribute value to represent the old state and the attribute value to represent the current state, included in the two-time-point context acquired, from the change storage unit; and
a transmission unit that transmits the searched member list difference.

2. The grouping apparatus as defined in claim 1, wherein:
amongst a plurality of attribute values representing a plurality of states of the user respectively, the acquisition unit acquires an attribute value which represents a state having changed after the attribute values of the user were previously acquired;
the grouping apparatus further comprises:
a cache storage unit that caches the attribute values of the user that were previously acquired in the acquisition unit; and
a context generation unit that, based on attribute values, which are currently acquired in the acquisition unit and which represent a changed state of the user, and attribute values, which were previously acquired and cached in the cache memory unit and which represent the state of the user, generates two-time-point context, which includes a plurality of attribute values to represent a plurality of current states of the user, and a plurality of attribute values to represent a plurality of old states of the user; and
the acquisition unit acquires the two-time-point context generated in the context generation unit.

3. The grouping apparatus as defined in claim 1, further comprising a registration unit that, after the key is generated based on the first attribute value and the second attribute value, associates and registers, in the change storage unit, the generated key and the member list difference, which shows the difference, between the first time point and the second time point, in the list of members belonging to the group which the user is allowed to join or leave, as the state of the user changes from the state at the first time point to the state at the second time point,
wherein the registration unit generates the search key with respect to a combination of the first attribute value and the second attribute value to match a restriction that is determined by a characteristic of a state represented by the first attribute value and the second attribute value.

4. A computer readable recording medium in which a grouping program to allow a user to join or leave one or more groups according to a state of the user is recorded, the grouping program allowing a computer to function as:
a change storage unit that associates and stores a key, which is generated based on a first attribute value to represent the state of the user at a first time point and a second attribute value to represent the state at a second time point, which is later than the first time point, and a member list difference, which shows a difference, between the first time point and the second time point, in a list of members belonging to a group which the user is allowed to join or leave, as the state of the user changes from the state at the first time point to the state at the second time point;
an acquisition unit that acquires two-time-point context, which includes an attribute value to represent an old state of the user and an attribute value to represent a current state of the user;
a search unit that searches for the member list difference corresponding to the key generated based on the attribute value to represent the old state and the attribute value to represent the current state, included in the two-time-point context acquired, from the change storage unit; and
a transmission unit that transmits the searched member list difference.

5. A grouping method to allow a user to join or leave one or more groups according to a state of the user, the grouping method comprising:
an acquisition step of acquiring two-time-point context, which includes an attribute value to represent an old state of the user and an attribute value to represent a current state of the user;
a search step of searching for, from a change storage unit that associates and stores a key, which is generated based on a first attribute value to represent the state of the user at a first time point and a second attribute value to represent the state at a second time point, which is later than the first time point, and a member list difference, which shows a difference, between the first time point and the second time point, in a list of members belonging to a group which the user is allowed to join or leave, as the state of the user changes from the state at the first time point to the state at the second time point, the member list difference corresponding to the key generated based on the attribute value to represent the old state and the attribute value to represent the current state, included in the two-time-point context acquired; and
a transmission step of transmitting the searched member list difference.
